(19) United States
(12) Patent Application Publication
(10) Pub. No.: US 2022/0353267 A1
(43) Pub. Date: Nov. 3, 2022

(54) FRAMEWORK FOR AUTOMATED OPERATOR ACCESS TO INFRASTRUCTURE IN A CLOUD SERVICE

(71) Applicant: Oracle International Corporation, Redwood Shores, CA (US)

(72) Inventors: Joydip KUNDU, Nashua, NH (US); Prasanna RAMAMURTHI, Bangalore (IN); Krishna CHANDER, San Ramon, CA (US)

(73) Assignee: Oracle International Corporation, Redwood Shores, CA (US)

(21) Appl. No.: 17/810,051

(22) Filed: Jun. 30, 2022

Related U.S. Application Data
(63) Continuation-in-part of application No. 17/245,943, filed on Apr. 30, 2021.

(51) Int. Cl. H04L 9/40

(52) U.S. Cl. CPC H04L 63/102; H04L 63/20

(57) ABSTRACT

Disclosed is an improved approach to implement a cloud access control mechanism. The mechanism provides customer control over access to cloud infrastructure by the cloud provider's operator employees, where the approach provides an override mechanisms for allowing operator access without additional customer approval based upon configured policies/rules.

### CROSS-REFERENCE TO RELATED APPLICATIONS

The present application is a Continuation-in-Part of application Ser. No. 17/245,943, filed on Apr. 30, 2021, which is hereby incorporated by reference in its entirety.

### BACKGROUND

In a cloud computing environment, computing systems may be provided as a service to customers. One of the main reasons for the rising popularity of cloud computing is that the cloud computing model typically allows customers to avoid or minimize both the upfront costs, as well as ongoing costs, associated with maintenance of IT infrastructures. Moreover, the cloud computing paradigm permits high levels of flexibility for the customer with regards to its usage and consumption requirements for computing resources, since the customer only pays for the resources that it actually needs rather than investing in a massive data center infrastructure that may or may not actually be efficiently utilized at any given period of time.

The cloud resources may be used for any type of purpose or applicable usage configuration by a customer. For example, the cloud provider might host a large number of virtualized processing entities on behalf of the customer in the cloud infrastructure. The cloud provider may provide devices from within its own infrastructure location that are utilized by the cloud customers. In addition, the cloud provider may provide various services (e.g., database services) to customers from the cloud. As yet another example, the cloud provider may provide the underlying hardware device to the customer (e.g., where the device is located within the customer's own data center), but handle implementation and administration of the device as part of the cloud provider's cloud environment.

One of the main functions performed by the cloud provider in the cloud computing model is the administration and maintenance of the cloud computing resources. By having the administrative staff of the cloud provider take control over these administrative tasks, this minimizes the need and costs for the customer to maintain its own IT staffing and infrastructure to handle these tasks, which is in essence one of the main advantages of the cloud computing paradigm for customers. To perform these tasks, the typical scenario is for the cloud provider's administrative staff to have full and unfettered ability to access and perform administrative functions within the cloud resources.

However, this model works poorly, or does not work at all, for regulated customers, such as banks and medical providers. The primary reason for this is that a regulated customer is, according to applicable contractual or legal requirements, supposed to be responsible for controlling the actions on every aspect of the system supporting their applications, and this responsibility is independent of the owner of the equipment or the origin of the staff performing actions on said equipment. Moreover, regulated customers often have to prove to their regulators that they are in complete control of these systems (e.g., in terms of knowing what actions were taken on the system), and that they are operating their systems in compliance with those regulations. These requirements for the regulated customers are in conflict with the conventional cloud computing scenario where the cloud provider's administrative operators—and not the cloud customer—have complete control over the cloud infrastructure resources.

A permissions mechanism can be provided to give customer control over access to cloud infrastructure by the cloud provider's operator employees, e.g., as disclosed in U.S. patent application Ser. No. 17/245,943, filed on Apr. 30, 2021, which is hereby incorporated by reference in its entirety. This mechanism will allow customer controlled access to cloud infrastructure that belongs to or is otherwise allocated to the customer, where a permissions model can be specified that requires explicit customer approval before certain kinds of operator access.

The issue addressed by this disclosure is that a permissions mechanism that requires human intervention before permitting operator access, e.g., in the form of an explicit customer approval, may introduce significant delays for operations that may be need to be urgently performed to keep the computing infrastructure in a functional state. However, permitting widescale automated operator access without such controls could create unacceptable security problems and would contravene the very point of having a customer controlled access mechanism. As is evident, there is a very real tension that exists between the desire for greater security against the desire for greater system availability.

Therefore, there is a need for an improved approach to implement a cloud computing environment that addresses the issues identified above.

### SUMMARY

Some embodiments are directed to an approach for implementing a system and method that strikes a balance between operator access control and service level guarantees in a cloud service. For a mechanism that provides customer control over access to cloud infrastructure by the cloud provider's operator employees, some embodiments of the invention provide an approach to create and enforce “override” conditions for allowing operator access without additional customer approval based upon configured policies/rules.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE FIGURES

The drawings illustrate the design and utility of some embodiments of the present invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 provides a high level illustration of this mechanism according to some embodiments of the invention.

FIG. 2A shows a flowchart of steps to configure and set up the customer controlled access mechanism according to some embodiments of the invention.

FIG. 2B shows a flowchart of steps to manage access by operators according to some embodiments of the invention.

FIG. 3 provides an illustrative view of the processing flows according to some embodiments of the invention.

FIG. 4 shows a cloud computing system that includes one or more cloud infrastructure resources that are used by one or more cloud customers.

FIG. 5 shows a high level flowchart of an approach to implement some embodiments of the invention.

FIG. 6A shows an example of a policy definition that does not include a policy override.

FIG. 6B shows an example operator access request.

FIG. 7A shows an updated version of the previously-discussed policy, where the updated policy includes one or more override conditions in the policy.

FIGS. 7B-C show example operator access requests.

FIG. 8 shows an illustration of an approach to implement validations for override requests.

FIG. 9 shows a flowchart of an approach to implement some embodiments of the invention, where a check is made to analyze for the legitimacy of the override requests.

FIG. 10 is a block diagram of an illustrative computing system suitable for implementing an embodiment of the present invention.

FIG. 11 is a block diagram of one or more components of a system environment in which services may be offered as cloud services, in accordance with an embodiment of the present invention.

### DETAILED DESCRIPTION OF THE EMBODIMENTS OF THE INVENTION

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments,” in various places throughout this specification are not necessarily referring to the same embodiment or embodiments.

Some embodiments are directed to an approach for implementing a system and method that strikes a balance between operator access control and service level guarantees in a cloud service. For a mechanism that provides customer controlled access (also referred to as “CCA”) to cloud infrastructure by the cloud provider's operator employees, some embodiments of the invention provide an approach to create and enforce conditions for allowing operator access without additional customer approval based upon configured policies/rules.

### Illustrated Example of CCA Mechanism

This disclosure will now provide an illustrated example of an approach to implement a mechanism to allow customer control over access to a cloud infrastructure.

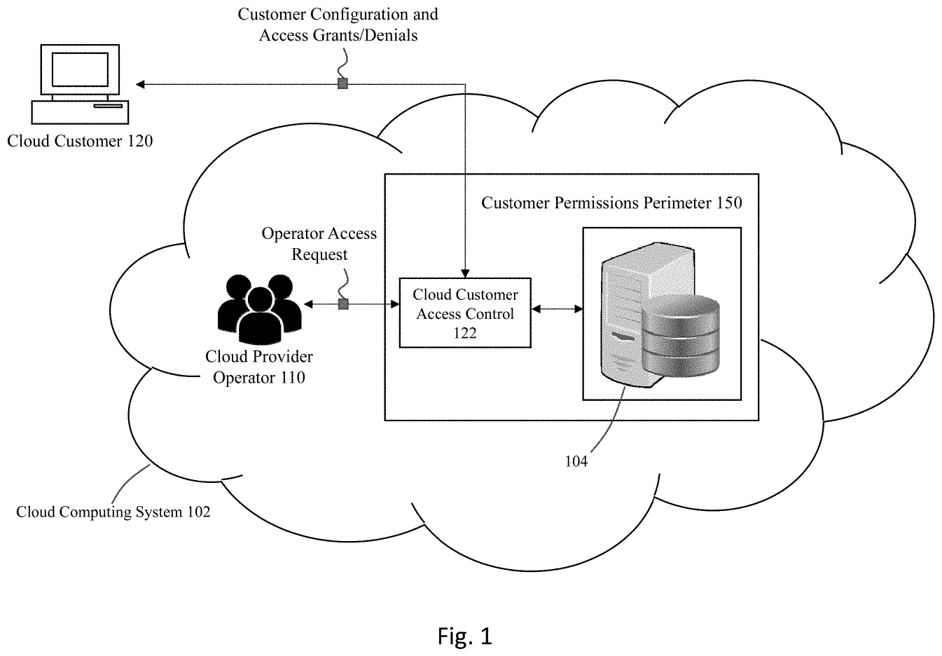

FIG. 1 provides a high level illustration of this mechanism according to some embodiments of the invention. This figure shows a cloud computing system 102 that includes one or more cloud infrastructure resources 104 that are used by one or more cloud customers 120.

The cloud infrastructure resources 104 correspond to any type of infrastructure resource that may be allocated and used within a cloud computing environment. For example, the cloud infrastructure resources 104 may correspond to a hardware device that is shipped to a customer to use in the customer's own data center, but where the device forms part of a cloud provider's cloud environment that is maintained by the cloud provider's administrative employees. In this cloud deployment model, the customer may be responsible for the application/user-space level activities on the device, e.g., the operation and implementation of virtual machines, and/or the management of database management software that reside on machine. However, the cloud provider is responsible for management of the infrastructure components for that device (e.g., chassis power, bare metal operating system, hypervisors, storage services, networking services, etc.). In an alternative embodiment, the cloud infrastructure resource 104 is owned by the cloud provider and located within the cloud provider's own data center.

In the conventional implementations of these models, the customer has unfettered access to components they are responsible for, and the cloud provider's employee administrators have unfettered access to components that the cloud provider is responsible for. While this model works for some portions of the cloud market, this model works poorly, or does not work at all, for regulated customers, such as banks and medical providers. As previously noted, the primary reason for this problem is that a regulated customer is responsible for controlling the actions on every aspect of the system supporting their applications, and this responsibility is independent of the owner of the equipment or the origin of the staff performing actions on said equipment. Moreover, regulated customers often have to prove to their regulators that they are in complete control of these systems, and that they are operating their systems in compliance with those regulations.

To address these issues, some embodiments of the invention provide a cloud customer access control mechanism 122 that allows a cloud customer 120 to implement customer control over access to the cloud infrastructure resources 104 by cloud provider operators 110. In effect, the cloud customer access control mechanism 122 creates a customer permissions perimeter 150 that allows the cloud customer to manage the extent, timing, and approval process for access to the cloud infrastructure resources 104 that are associated with the cloud customer 120.

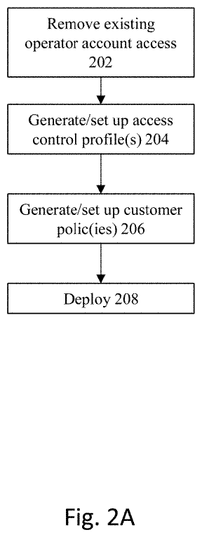

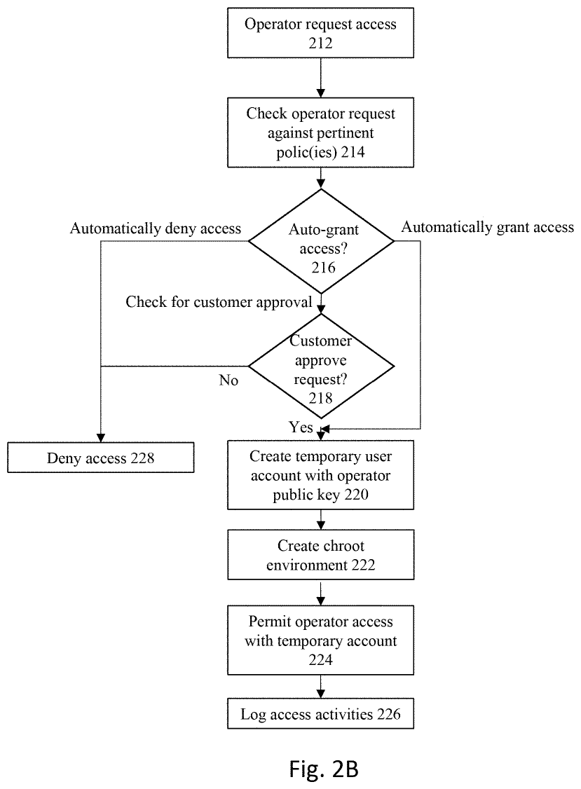

FIG. 2A shows a flowchart of steps to configure and set up the customer controlled access mechanism according to some embodiments of the invention. At step 202, existing operator accounts are removed from the system. Prior to implementation of the invention, it is possible that the cloud provider's employee operators have already been provided access to the cloud infrastructure, and hence user accounts have already been created and currently exist for these cloud operators. Step 202 is performed to remove or otherwise disable these accounts so that cloud operators will no longer be able to use these previously-created accounts to access the cloud infrastructure.

At 204, one or more access control profiles (“ACPs”) are created in the system. These access control profiles pertain to named and pre-defined profiles of the commands/files/network which can be accessed on a given layer. In some embodiments, these profiles are established and owned by the cloud provider.

The kind of control that can be enforced by ACPs defines the technology chosen to implement the possible enforcements. The enforcement can be on any level of granularity, e.g., at the user level, file system level, kernel access level, and/or on a resources level such as, for example, for a CPU or memory.

The control profiles may be used to enforce a semi-sandbox state, and may enforce what a cloud operator user can access in the system. The control profiles may also be used to enforce what the cloud operator is permitted to do in the system, e.g., pertaining to execution of shell (OS) commands, operator-developed scripts, database commands, cloud tooling commands, and/or DB client tools.

By way of illustration, an example profile called “DOMO FILE SYSTEM DEBUG” may be configured having the following parameters: (a) this profile has read-only access to all files on DOMO; (b) this profile cannot execute any command to leave the DOMO; (c) this profile cannot start any child shell; (d) this profile cannot write anything to the filesystem.

At step 206, one or more customer control policies (CCCA policies) may be generated and/or configured. This is a customer-defined entity which contains a grouping of the access control profiles that are allowed and/or restricted. The policy may include a list of customer users who have permissions to approve/revoke access. In some embodiments, the CCA policy may define criteria for the users who may access the infrastructure. This could be due to, for example, legal requirements of the customer's industry and/or contractual requirements imposed upon the customer.

In some embodiments, the CCA policy is created by a customer with some or all of the following attributes: (a) policy name, where the policy name should be a unique name within the tenancy; (b) identification of customer users with approval rights, which are the rights to approve access requests; (c) a policy description; (d) user attributes of the policy, which pertain to rules for the users who will request access; (e) ACPs which are automatically approved as per the policy, and in which ACPs not explicitly allowed will require approval; and/or (f) policies that are audit-only, where all ACPs are allowed automatically with only access logging enabled.

Thereafter, at step 208, the various policies are deployed within the system. This is the action by which the one or more policies are associated with cloud resources within the system. Once the policy has been deployed, any operator access to the resource will be governed by the policy. The deployment can be of any length of time, e.g., made permanent or for only a specific duration.

FIG. 2B shows a flowchart of steps to manage access by operators according to some embodiments of the invention. At 212, a request is received for access by an operator to a cloud resource. In some embodiments, the request includes one or more of the following: (a) the identifier of the specific resource for which access is requested; (b) the ACP that is being requested by the operator; (c) the time duration for the request; and/or (d) for auditing purposes, the reason for which the request is being made.

At 214, the operator request is checked against the polic(ies) that are pertinent to the request. At 216, a determination is made whether the automatic approval can be made for the access request. With certain embodiments of the invention, distinctions are made between different types of requests, where certain requests are deemed appropriate for automatic processing, while other requests are deemed appropriate for explicit customer approvals. For example, certain types of ACPs that pertain to read-only access of non-sensitive system information may be designated as eligible for automatic approvals (subject to logging as described in more detail below). However, other types of access to more sensitive information or activities may require explicit customer approval.

If the request is of the type that should be automatically denied, then the process will proceed to step 228 to deny the requested operator access. On the other hand, if the request is of the type that should be automatically approved, then the process will proceed to step 220 to implement steps to allow access by the operator.

If the access request is not of a type that would be amenable to automated approval/denial, then the processing will proceed to step 218, where an additional check is made with the customer to determine whether the customer will approve or deny the requested operator access. In particular, the request will be routed to the designated approver entity/user at the customer to receive the customer instruction for how to proceed.

The access requested by the operator user is mapped to a set of approving customer users. This mapping is done through the CCA policy that is in-force on the corresponding resource. The CCA system checks if the user attributes of the policy and the requesting Ops user are compatible. If not compatible, the system auto rejects the request. When the access request is raised, there is an event posted on the corresponding CCA policy system field/location stating an access request is pending for approval, which triggers a notification to the appropriate customer user(s). The customer user would then log in to approve/deny the corresponding access request. During the approval process, the customer user can change the duration for which the access is sought. The customer may also request additional logging for this access.

Upon approval for the operator access, at step 220, a temporary user account is created for the operator access on the target resource. For example, in some systems, a new user (e.g., a Linux user) can be created on the target resource. The user is created to ensure clear access control and auditability for the operator user actions. As the user is created as a new temporary account, there is no existing privilege in the system. The user is deleted once the access expires and hence it is a clear removal of privilege.

In particular, the new temporary user is created that is seeded using the public key for the operator for which the request is being sought. To generate this user, the CCA system will log into the corresponding layers to create the user, where this login is a performed as root. The temporary user that is created will only have the permissions granted by the specific ACP approved by the customer. After the temporary user is dynamically generated, the username and key are posted to the requesting operator user.

Next, at step 222, a chroot environment is created for the temporary user account. A chroot on a Unix-based operating system (such as Linux) is an operation that changes the apparent root directory for the current running process and its children. The programs that run in this modified environment cannot access the files outside the designated directory tree. This essentially limits their access to a directory tree and thus they get the name “chroot jail”. This means that the cloud operator will only be able to perform its activities within the scope of the directory tree for the chroot environment that is created for the temporary user account.

At 224, the operator will now be permitted to access the cloud resource using the temporary username that has been created for the operator using the operator's public key. For example, the operator may use a secure shell (SSH) to perform key-based log-in to access to the cloud resource using the temporary username that has been created for the operator.

Thereafter, the operator will be permitted to perform the activities permitted by the corresponding ACP. For example, the allowed activities may include a defined set of commands executable by the operator user. These commands could be direct like issuing a “ls” on the linux machine or indirect like a shell script executed which invokes “ls”. Activities are limited to this definition and not further such as syscalls invoked or the libraries invoked by the user. It is possible that in some cases there is a delegated execution where a command is executed by the user which submits a request to a daemon running on the system. This daemon performs the command on behalf of the user. These also will be logged.

At step 226, the activities by the operator user are logged by the system. The activity monitoring is performed through audit logs generated for the activities performed by the operator, with logs being made available to the customer. One aspect of the monitoring is the ability to post the monitor logs to the customer. In some embodiments, the posted logs will include one, some or all of the following information: (a) identifier of the resource from where the logs are generated; (b) layer from which the logs are generated; (c) the user ID generating the log; (d) the access request ID which granted the access; (e) timestamp of the log. Various types of logging may be implemented, including for example, one or more of the following: (a) keystroke logging; (b) capture of all OS commands executed by operator; (c) logging of all commands executed through a script; and/or (d) logging of commands executed by a delegate (such as a daemon). The time interval may be configured as desired for the logging, e.g., with small time intervals such that the logging is in near-realtime.

At the expiry of the time duration for the operator access, the system deletes the temporary user from the target endpoint. This action may also occur upon an explicit action by the customer to revoke access. This will remove the ability of the operator to access the system.

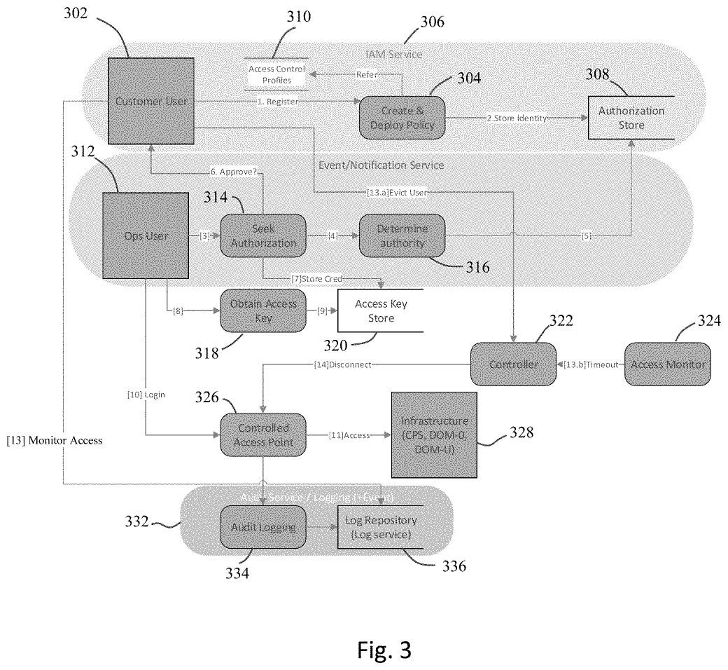

FIG. 3 provides an illustrative view of the above-described processing flows according to some embodiments of the invention. At (1), the customer user 302 will perform registration of one or more deployment policies 304, which would at (2) be stored within an authorization store 308. The deployment policies 304 may refer to one or more access control profiles 310. These action may take place in the context of any appropriate management layer within the system. In some embodiments, an IAM (identity and access management) service 306 is employed to implement these actions.

At (3), an operator user 312 may submit an access request 314 to seek authorization to access a specified cloud resource. At (4) a determination is made by module 316 as to whether the operator user has the authority to seek the requested access permissions. At (5), this determination may be performed by checking against the authorization store 308. At (6), the request maybe forwarded to the customer user 302 to determine whether the customer will approve or deny the operator's request for access to the cloud resource. It is noted that some or all of these actions may be implemented as an event/notification service 330.

At (7), the credentials for the authorization may be stored within the access key store 320. These credential may be associated with a new temporary user account that is created for the operator user. At (8), an access key 318 may be obtained with respect to the user, e.g., based upon the operator user's public key. At (9), this access key is also stored within the access key store 320.

At (10), the operator user 312 will log into the cloud resource via a controlled access point 326 that is controlled by controller 322. The operator user 312 will log in using the temporary user account that has been created upon approval for the requested access.

At (11), the operator user 312 will thereafter perform its access of the cloud resource 328 for which approval had been granted. An audit/logging service 332 will perform logging 334 of the activities of the operator user 312. The captured logs will be stored within a log repository 336. At (12), the customer user 302 may choose to monitor the access activities of the operator user 312, e.g., by accessing the logs within the log repository 336.

The access privileges of the operator user 312 may later be revoked. This may occur, at (13a), by command of the customer user 302 to the controller 322 to evict the operator user 312. Alternatively an access monitor 324 may note the expiration of the designated time period of the access grant, and at (13b) issue a notification to the controller 322 of the timeout that has occurred for the access rights of the operator user 312. At this point, the controller 322 will operate the controlled access point 326 to revoke access to the operator user 312.

### Illustrated Example of Mechanism to Balance Operator Access and Customer Control Over Access

This disclosure will now provide an illustrated example of an approach to implement a mechanism that strikes a balance between operator access control and customer control over access in a cloud service.

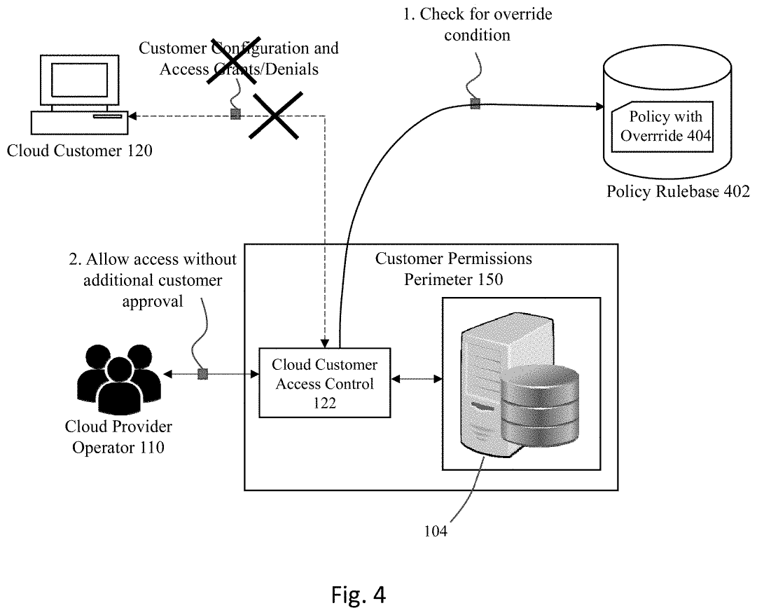

FIG. 4 shows a cloud computing system that includes one or more cloud infrastructure resources 104 that are used by one or more cloud customers 120. As previous noted, this type of cloud-based computing provides numerous benefits, such as providing demand-driven elasticity of resources, self-service provisioning/deprovisioning, centralized pooling of resources, SLA (service level agreement) based availability/reliability for services, and reduced costs in IT infrastructure, maintenance, and lifecycle management including a reduction in day-to-day administration overhead.

The system includes a cloud customer access control mechanism 122 that allows a cloud customer 120 to implement customer control over access to the cloud infrastructure resources 104 by cloud provider operators 110. A customer permissions perimeter 150 allows the cloud customer to manage the extent, timing, and approval process for access to the cloud infrastructure resources 104 that are associated with the cloud customer 120. With this type of customer access control, a cloud customer 120 can bring critical infrastructure under compliance controls in terms of preventive, detective, and corrective control.

The issue addressed by embodiments of the invention is that such a service where control resides with the customer has the potential for affecting service delivery, e.g., in terms of meeting SLAs (service level agreements). An SLA may include terms contracted by the customer that specify a minimum and/or guaranteed requirement for availability and/or delivery of a service that is provided through the cloud infrastructure. At some point in time, to maintain availability of the cloud system or services running in the system, an operator will likely need to obtain urgent access the cloud infrastructure. However, the requirement to obtain customer approval in real time for the operator access can lead to delays in the ability of the operator to keep the system up and running. This delay can lead to violation of the terms of the SLA, as well as other unacceptable interruptions in service.

Embodiments of the invention provide a mechanism that can override a requirement to obtain customer approval for the operator access. This is implemented by identifying one or more scenarios where the lack of ability of an operator to intervene affects the availability of the service. For these scenarios, the system implements compensating mechanisms that allow the system to strike a balance between the customer control and the service level guarantee. As discussed in more detail below, the mechanism is applied to only limited circumstances, and are likely to occur only rarely, hence the compensation mechanism will not undermine the fundamental assurances of operator access control.

The system includes a policy rule base 402 that holds the policies applied by the cloud control access control mechanism 122. The terms of the policies within the policy rulebase 402 are used by the cloud control access control mechanism 122 to control whether a given operator access will be automatically granted, or where further customer approvals are need to provide access to the operator.

With embodiments of the invention, the policy rule base 402 includes one or more polices 404 that include an override provision to permit operator access without real time customer approval in certain circumstances, even where normal circumstances would otherwise dictate that such customer approvals are required. At (1), a check is made of whether the override condition specified in the policy 404 is met by the current system situation/status. If so, then at (2), access is provided to the operator without requiring additional customer approvals at that time.

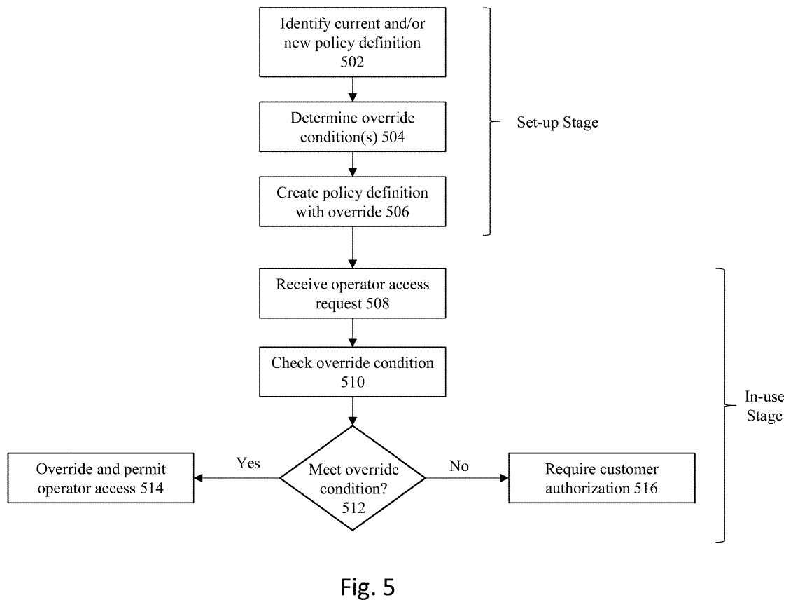

FIG. 5 shows a high level flowchart of an approach to implement some embodiments of the invention. The process generally includes both a set-up stage and an in-use operational stage.

During the set-up stage, a policy is created that includes an appropriate override mechanism for a given type of operator access. At 502, a policy is identified that may be appropriate for the override mechanism. The policy may be an existing policy that is currently in-force and used to control access by an operator to the system. Alternatively, the policy may be a brand new policy that is being implemented for the first time in the system.

At 504, one or more override conditions are identified for the policy. As previously noted, the goal is to strike a balance between the customer control and the service level guarantee. This balance can be obtained by limiting the circumstances in which such override conditions are applicable. In some embodiments, there is the consideration that there are two broad cases where service level guarantee can be negatively impacted because of the presence of such control with the customer, and the current invention is used to provide a way to accommodate SLA-impacting events via a policy definition. A first case is an urgent event handling situation, where each access request from the operator needs to be approved by the customer and any delay in such an approval may adversely impact the service. Here, an adverse effect can be exacerbated in scenarios with a history of operator intervention requirements such as necessary maintenance windows, an imminent hardware failure, and/or or a security incident. A second broad case pertains to the situation where an access request is associated with an operator, and the situation could create interference with potential collaboration and handovers. For example the following situations may arise when (a) an operator detects an issue and raises an access request, and the request is approved after the operator's shift has ended; the new operator will have to raise the access request again, and pay the time-cost associated with customer approval once again; (b) an operator wants to collaborate with another operator to debug a problem; the second operator will need to ask for permission from the customer (with an additional time-delay in explicit approval); (c) an operator wants to engage the expertise of a Subject Matter Expert (SME) in resolving a problem, but the SME does not have the authorization to request access to the customer infrastructure.

The override condition would be defined to include the circumstances under which the override would be applicable. For example, per the first case discussed above, an override condition may be defined to permit operator access during the occurrence of a maintenance windows, an imminent hardware failure, and/or or a security incident. At 506, the policy definition is created that includes the desired override condition. Examples of such policy definitions are discussed and provided in more detail below. In effect, step 504 is performed to identify a set of conditions that can impact SLA, and step 506 is performed to provide one or more policy extensions to handle these situations. These steps operate to identify different collaborations that happen during problem resolution and which will provide policy extensions to make such collaborations seamless.

During the in-use phase, at 508, an operator may submit a request a request for access to the system. As described in more detail below, the operator request will include sufficient information to be able to verify whether or not the situation is appropriate for an override.

At 510, the information within the operate access request is checked against the policy to determine if an override condition would permit the operator to obtain access without customer approval. A validation check may also be performed to ensure that access requests are only approved using this override process when the underlying events actually justify such approval.

At 512, a determination is made regarding whether the override conditions have been met. If so, then at 514, the operator is given access to the system without requiring customer approval. On the other hand, if the override conditions have not been met, then at 516, the operator is not given access to the system unless customer approval is obtained.

This approach therefore provides a policy-based control that can be utilized by the customers to address both the issues of urgent event handling and allowing seamless collaboration among operators. The customer can tailor their operator control policies to allow for automatic approval of certain categories of requests so that operator access is not unduly delayed, while enforcing required customer approvals in other situations.

The policies in the system can be defined with respect to specific types of actions or operations to be performed in the system. The following are examples of actions that can be exposed using a policy: (a) INFRA DIAG: which pertains to actions to perform diagnosis operations; (b) INFRA MAINT RESTART: which pertains to performing maintenance operations; (c) INFRA HYPERVISOR: which pertains to performing hypervisor-related operations; and/or (d) INFRA SYSTEM: which are system-level operations, such as actions taken with root-level of access.

The policies may also define the level or type of approval that is needed to perform a given type of operation. For example, the keyword “pre_approved” refers to a level of approval where the access is automatically granted to the operator for access. In contrast, the keyword “approver” refers to a condition where explicit customer approval is required based upon an identified approver or group/set of approvers that may be listed following the keyword.

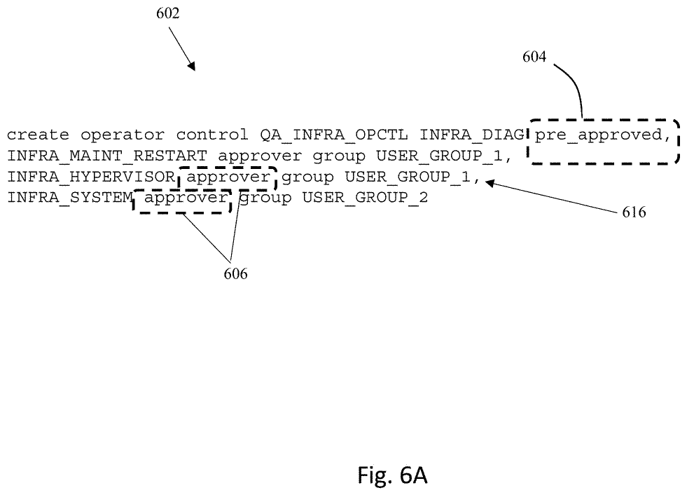

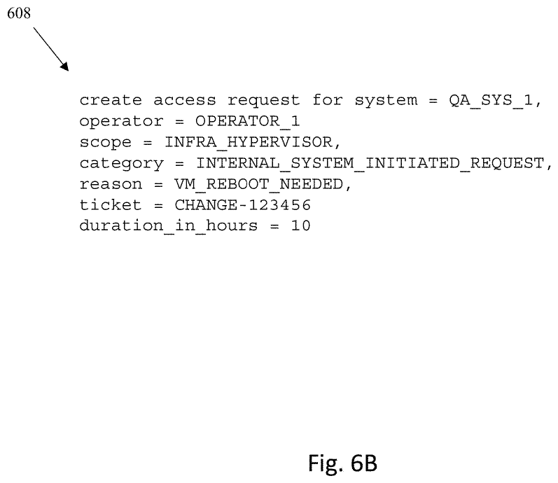

FIG. 6A shows an example of a policy definition 602 that does not currently include a policy override. Here, the policy definition 602 states that for an infrastructure placed under QA_INFRA_OPCTL, any access requests for INFRA DIAG or INFRA MAIN RESTART will be automatically approved without any manual intervention, given the keyword 604 for “pre_approved” for these actions. However, given the keyword 606 for “approver . . . ” in this definition, an access request asking for the INFRA HYPERVISOR action will be approved by USER_GROUP_1 and an access request asking for INFRA SYSTEM action will be approved by USER_GROUP_2.

An access request raised by the operator identifies certain pertinent information to be evaluated for determination of access for the operator. Such information may include, for example, the system to be accessed, the scope of access, the category of access (whether it was the result of an internal alert i.e., INTERNAL SYSTEM INITIATED REQUEST, or the result of a customer initiated request i.e., CUSTOMER INITIATED REQUEST), the reason the access is needed, a link to the original ticket (the link points to different databases depending on whether the request is a result of an internal alert or an external service request), and/or the duration for the access request.

FIG. 6B shows an example operator access request 608. This example request uses the keyword “system” to identify the specific system for which the request is being made, the keyword “operator” to identify the specific operator making the request, the keyword “scope” to identify the scope of the access request, the keyword “category” to identify the type/category of the access request, the keyword “reason” to identify the reasons/basis of the request, the keyword “ticket” to identify the ticket ID corresponding to the request, and/or the keyword “duration” to identify the duration of the access period.

As stated in the access request of FIG. 6B, the operator is requesting access for performing an operation upon the hypervisor based upon the term “INFRA HYPERVISOR” in the “scope” field. Referring back to the policy definition 602 in FIG. 6A, portion 616 of the policy indicates that such access requests cannot be granted unless approval is obtained from the user (e.g., based upon the statement “INFRA HYPERVISOR approver group USER_GROUP_1”, which requires a customer user from USER_GROUP_1 to approve the request). If the access request is based upon an urgent event, then this requirement to wait for customer approval and possibly incur a significant delay before allowing the operator to obtain access could result in a service interruption and/or SLA violation.

It is noted that there are certain events or periods which have a higher probability of a need of an operator intervention. The probability can be discovered through analysis of historical data and experience. Such events may not necessarily be fixed, and change can be made as more data is acquired and as the service changes.

In the current embodiment, there are three such events and/or periods that can be identified have a higher probability of a need for an operator intervention, including one or more of: (a) Maintenance Windows, e.g., where the infrastructure is patched; (b) Hardware Failure Events, e.g., where either the hardware has failed or there is an indication of imminent failure; and/or (c) Security Incidents, e.g., a zero day or security vulnerability. These events or periods correspond to situations during which an operator may need immediate approval to access the infrastructure regardless of the operator control policy placed on the system. This is accomplished by including an additional override clause for explicit approval during the definition of an operator control. Thus, there are three overrides available to the customer: maintenance_window, hardware_incident, and security_incident. Such overrides can be associated with individual scope of access profiles.

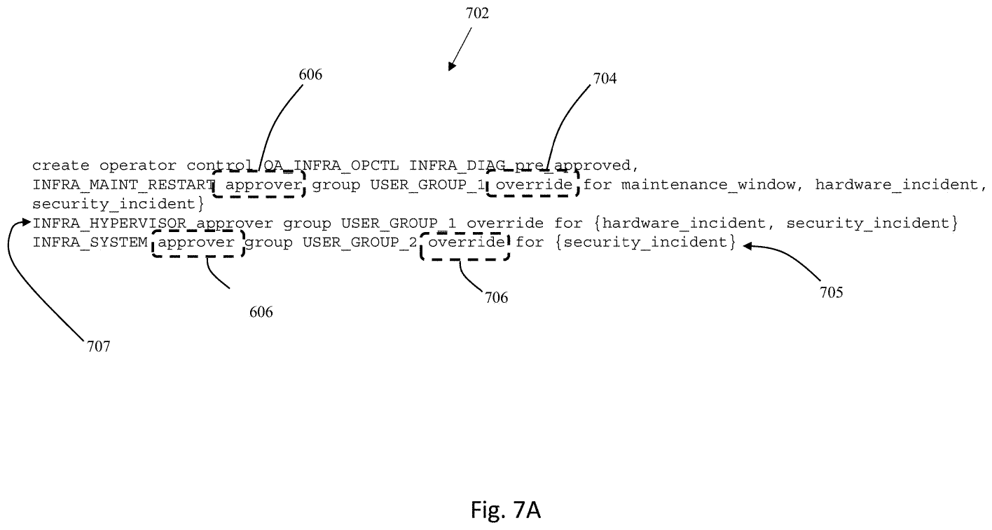

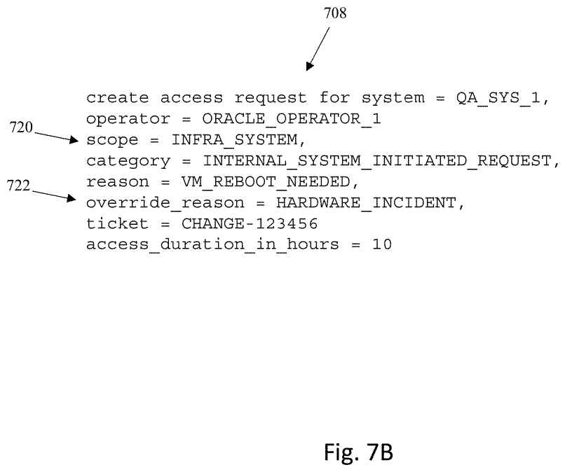

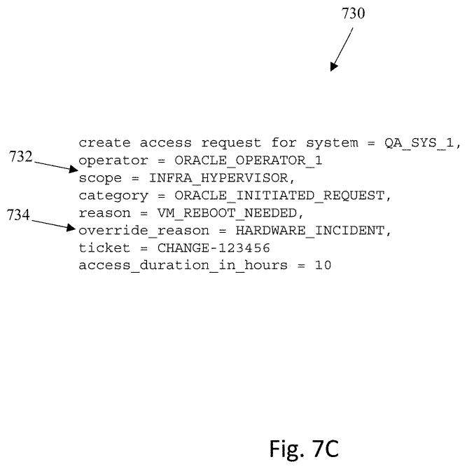

FIG. 7A shows an updated version 702 of the previously-discussed policy 602, where the updated policy 702 includes one or more override conditions in the policy. Regarding the portion directed to INFRA DIAG, this updated policy is the same as the previous policy 602 in that approval is always automatically granted, so no override is needed.

For INFRA MAIN RESTART, the keyword 606 for “approver” means that this usually requires approval from USER_GROUP_1. However, the keyword 704 for “override” indicates that the requirement to obtain approval may be overridden under certain conditions. Here, the requirement to obtain customer approval is overridden for the following conditions: maintenance_window, hardware_incident, or security_incident.

Similarly, for INFRA HYPERVISOR, the keyword 606 for “approver” for this portion of the definition means that this usually requires approval from USER_GROUP_1. However, the keyword 706 for “override” indicates that the requirement to obtain approval may be overridden under certain conditions. The following conditions are specified to override the requirement obtain customer approval: hardware_incident or security_incident.

From the operator side, the access request may add one or more appropriate parameter if the request needs to be approved immediately, where the one or more parameters pertain to at least one of the override conditions. Those conditions are evaluated against the parameters in the request to determine if the operator access is to be granted automatically as an override.

Consider if an operator needs to obtain access to the system, perhaps because the operator needs access at INFRA SYSTEM level and there is a hardware_incident. FIG. 7B shows an example operator access request 708. This example request uses the keyword the keyword “scope” at portion 720 to identify the scope of the access request as pertaining to INFRA SYSTEM, and the keyword “override reason” at portion 722 as a “HARDWARE_INCIDENT” that has occurred.

Referring back to the policy definition 702 shown in FIG. 7A, it can be seen that this particular access request 708 does not meet the condition for an override. This is because the override section of the policy at line 705 directed to INFRA SYSTEM only permits an override for INFRA SYSTEM for “security_incident” situations. Here, since the access request 708 only identifies a hardware_incident for INFRA SYSTEM at 720 and 722 (and not a security_incident), this means that the condition for the override has not been met. Therefore, the access request will have to undergo the standard approval process of requiring approval from the customer (someone within group User_Group_2).

Consider another situation where the operator needs to obtain access to the system, perhaps because the operator needs access at INFRA HYPERVISOR level and there is a hardware_incident. FIG. 7C shows an example operator access request 730. This example request uses the keyword the keyword “scope” at portion 732 to identify the scope of the access request as pertaining to INFRA HYPERVISOR, and the keyword “override reason” at portion 734 as a “HARDWARE_INCIDENT” that has occurred.

Referring back to the policy definition 702 shown in FIG. 7A, it can be seen that this particular access request 708 does meet the condition for an override. This is because the override section of the policy at line 707 directed to INFRA HYPERVISOR permits an override for any situations that include “hardware_incident” or “security_incident”. In the current example situation, since the access request 730 only identifies a hardware_incident for INFRA HYPERVISOR, this means that the condition for the override has been met. Therefore, the access request will be automatically granted without having to undergo the approval process of requiring approval from the customer.

Some embodiments of the invention provide an approach to ensure the legitimacy of the override requests. One of the main value propositions of the customer access control is the idea that a customer written policy requiring explicit approval should generally be honored. Therefore, to the extent that policies may include override conditions, the system should have some protections in place to make sure that any override requests are really legitimate.

With the current embodiment of the invention, information from external systems or entities are used to verify the validity of override request. These systems or entities are external to the customer access control system, and these external systems are used to track additional incidents/information in the system. For example, if an override request is based upon the occurrence of an incident (e.g., a security or hardware), then confirmation of the existence of the incident in an external system would be useful as a tool to perform validation of the override request. If the specific incident identified in the override request can be validated in an external system that tracks that type of incident, then this type of confirmation could be used to permit the override to proceed to the operator access. On the other hand, if the external system cannot independently verify the incident, then this is an indication that the override request should be denied.

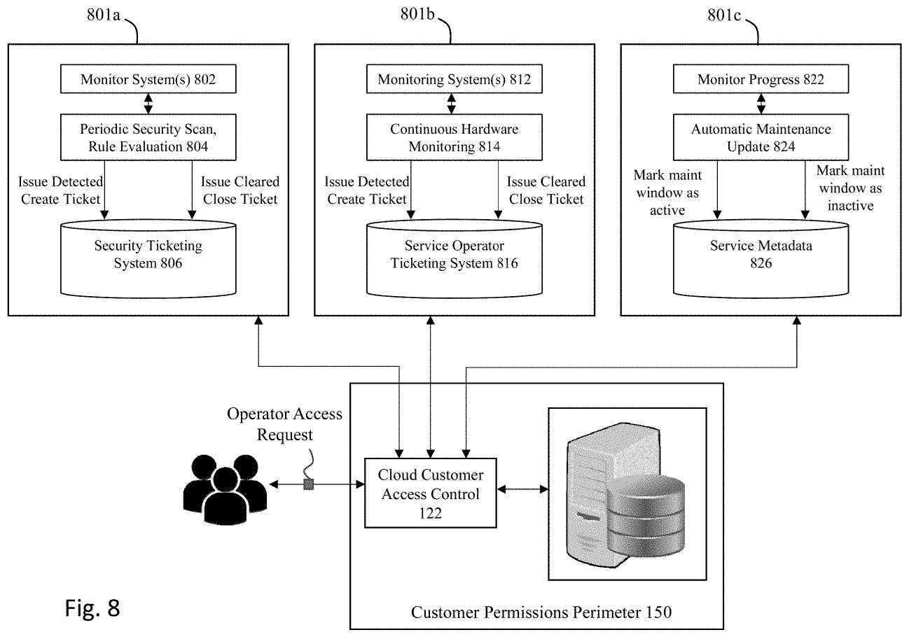

FIG. 8 shows an illustration of an approach to implement validations for override requests. Here, three external systems are shown that can be used in conjunction with the cloud customer access control 122 in the customer permissions perimeter 150 to assist in validating override requests. System 801a corresponds to a system for tracking security information/incidents. System 801b corresponds to a system for tracking hardware information/incidents. System 801c corresponds to a system for tracking maintenance information.

The cloud environment may employ a system 801a to handle security functionality within the environment. For example, system 801a may be used to provide malware protection and detection, and may also be used to protect against intrusions from malicious third parties. The system 801a may use one or more modules to monitor the various systems within the cloud environment for security issues. Any security incidents that are detected by may be recorded and stored as tickets within the security tracking system 806. A periodic security scan and security rule(s) evaluation 804 may occur on a regular basis to perform the security monitoring. When issues are detected, a ticket may be created within the security ticketing system 806. An operator may only access these tickets in read-only mode, and cannot manually create such tickets. A ticket record within the system may identify certain items of information that would be useful for administrators and operators in the system, such as the identification of the system having the incident, a ticket identifier/number, the current status of the ticket (e.g., “open” or “closed”), and/or the scope/type of the incident. When the security indicant associated with the ticket has been resolved, then the ticket would be marked as being closed within the ticketing system 806.

When an override request is received from an operator that pertains to a security incident, the customer access control mechanism 122 will communicate with the security system 801a. A check is made to verify whether the information in the access request corresponds to the data maintained in the security ticketing system 806. For example, a check is made to verify that the security incident referenced in the access override request actually exists in the security system, and furthermore, that the ticket is still open and has not already been closed on the target infrastructure. If the information for the security incident in the access override request is validated by the external system 801a, then the access request could indeed be considered as valid (while possibly subject to other requirements as well).

The cloud environment may employ another external system 801b to handle hardware incident tracking within the environment. Some cloud systems self-monitor for hardware issues, where alert messages are written in an alert file for hardware issues. In the current embodiment, the cloud service monitors the alert logs at module 812. Any suitable type of monitoring may be employed. For example, at 814, continuous monitoring may be employed upon the alert logs. When monitoring the alert logs, detection of a hardware incident will cause the creation of a ticket in a service ticketing system 816. A ticket record can be created with a unique identifier of the specific infrastructure, and the same ticket may contains the original alert log snippet that contains the error message. When the hardware issue has been resolved, then the ticket can be closed in the ticket database 816.

When an override request is received from an operator that pertains to a hardware incident, the customer access control mechanism 122 will communicate with the system 801b. The access control mechanism can check and review the metadata for the infrastructure with HARDWARE_INCIDENT label, where the alert message number is associated with the hardware incident, and with the ticket number of the incident. The system checks to make sure that the ticket# provided matches the Infrastructure ID, and that it was auto-cut (e.g., created by automation and not by human). When an alert clears or the open ticket is closed, a callback is triggered to Operator Access Control so it can clear the metadata associated with the Infrastructure of the label/error message/ticket#. The Operator Access Control can be configured to maintain a map of hardware error message to know whether operator access is critical to resolve the issue. Therefore, when an operator access request is received, it does the following checks: (a) look at the metadata and ensures that it is tagged with the label HARDWARE_INCIDENT; (b) check the ticket# associated in metadata to ensure that the ticket is still open. Since Operator Access Control checks to validate the ticket#, label, and Infrastructure ID at the time of tagging its metadata, and the operator has no way to directly change this metadata, this ensures that an operator can ask for override of explicit approval only for a system that has an active hardware incident.

The cloud environment may employ another external system 801c to handle tracking of maintenance information within the environment. In some embodiments, the infrastructure maintenance windows are specified by customers. This metadata is kept in the customer's tenancy and operators have read access but no write access to the preferred maintenance window of the customer. The system 801c uses a module 822 to monitor progress of maintenance operations in the infrastructure, where automatic maintenance updates are performed at 824. This produces service metadata that are stored in metadata database 826. The automation software that implements automated maintenance activity will mark the metadata with the actual maintenance start and (when complete) end times. So a customer can specify a preferred maintenance window of 2 pm-6 pm on Jul. 21, 2022, even though the actual maintenance may start at 4 μm and finish by 5:30 pm on Jul. 21, 2022.

When an override request for MAINTENANCE_WINDOW is submitted, Operator Access Control will consult the maintenance metadata and make sure that actual maintenance has started (e.g., actual maintenance start time is filled in and it falls within the preferred window specified by the customer) and is ongoing (e.g., actual end time is empty). If the information for the maintenance incident in the access override request is validated by the external system 801c, then the access request could be considered as valid.

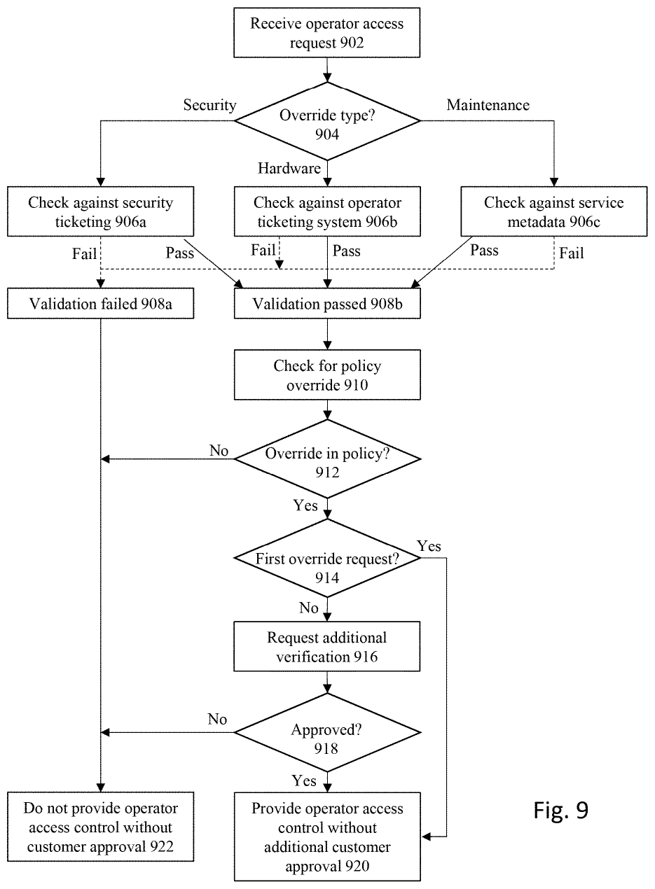

FIG. 9 shows a flowchart of an approach to implement some embodiments of the invention, where a check is made to analyze for the legitimacy of the override requests. At 902, an operator access request is received for processing, where the access request corresponds to an override request. Any suitable form of the access request may be used in embodiments of the invention. FIGS. 7B-C provide examples of operator access requests that corresponds to override requests.

At 904, determination is made of a specific basis type for override request, e.g., whether the request pertains to hardware incident, security incident, and/or maintenance window. If the request corresponds to a security incident, then at 906a, the information in the access request is checked against the external security system for validation. If the request corresponds to a hardware incident, then at 906b, the information in the access request is checked against the external hardware system for validation. If the request corresponds to a maintenance window, then at 906c, the information in the access request is checked against the external maintenance system for validation. Generally, a check is made to determine if the override request corresponds to an open ticket with the correctly identified ticket/system information. If so, then the access request has passed the validation check.

If not, then validation has failed. If the validation failed at 908a, then the process proceeds to 922, where the access control mechanism will not provide the operator with access at this point without first obtaining customer approval for the access.

However, if the validation succeeded at 908b, then the process proceeds to step 910 to check whether the policy allows for an override. This action checks for the presence of the “override” keyword in the policy definition, which allows for override automatic approval. If this override portion does not exist in the policy definition, then the process proceeds to 922, where the access control mechanism will not provide the operator with access at this point without first obtaining customer approval for the access.

If the policy permits an override, then the process further proceeds to step 914 to check whether this is the first override request. The issue addressed by this determination is that due to the periodic nature of the way that tickets may be updated/closed in the external systems, it is possible that a previous operator override request had already resolve the incident, but the lag in updating the ticketing database(s) means that the ticket was still “open” during the earlier validation check. In this situation, it would be a mistake to grant the new override request. To resolve such loopholes, the current embodiment will check whether the current override request is the first such request. If so, then the process proceeds to step 920 to permit operator obtain access with automatic override approval. On the other hand, if this is not the first override request, then the proceeds to step 916 to obtain additional verification of the access request. For example, the request may be forwarded to an operations manager for a manager verification. If the manager approves at step 918, then the process proceeds to step 920 to permit operator obtain access with automatic override approval. If the manager does not approve (or a timeout period is reached), then the process proceeds to 922, where the access control mechanism will not provide the operator with access at this point without first obtaining customer approval for the access.

Therefore, what has been described is an improved approach for implementing a system and method that strikes a balance between operator access control and service level guarantees in a cloud service. For a mechanism that provides customer control over access to cloud infrastructure by the cloud provider's operator employees, some embodiments of the invention provide an approach to create and enforce conditions for allowing operator access without additional customer approval based upon configured policies/rules.

### System Architecture

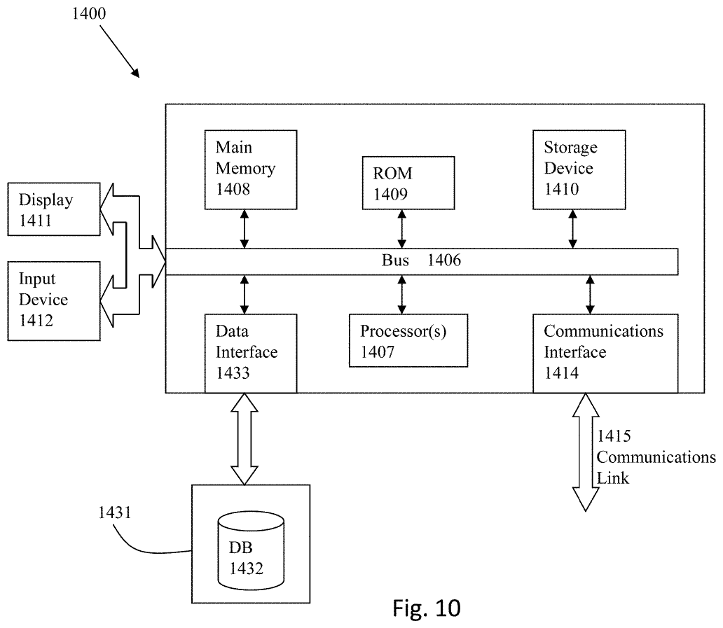

FIG. 10 is a block diagram of an illustrative computing system 1500 suitable for implementing an embodiment of the present invention. Computer system 1500 includes a bus 1506 or other communication mechanism for communicating information, which interconnects subsystems and devices, such as processor 1507, system memory 1508 (e.g., RAM), static storage device 1509 (e.g., ROM), disk drive 1510 (e.g., magnetic or optical), communication interface 1514 (e.g., modem or Ethernet card), display 1511 (e.g., CRT or LCD), input device 1512 (e.g., keyboard), and cursor control.

According to some embodiments of the invention, computer system 1500 performs specific operations by processor 1507 executing one or more sequences of one or more instructions contained in system memory 1508. Such instructions may be read into system memory 1508 from another computer readable/usable medium, such as static storage device 1509 or disk drive 1510. In alternative embodiments, hard-wired circuitry may be used in place of or in combination with software instructions to implement the invention. Thus, embodiments of the invention are not limited to any specific combination of hardware circuitry and/or software. In some embodiments, the term “logic” shall mean any combination of software or hardware that is used to implement all or part of the invention.

The term “computer readable medium” or “computer usable medium” as used herein refers to any medium that participates in providing instructions to processor 1507 for execution. Such a medium may take many forms, including but not limited to, non-volatile media and volatile media. Non-volatile media includes, for example, optical or magnetic disks, such as disk drive 1510. Volatile media includes dynamic memory, such as system memory 1508.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1500. According to other embodiments of the invention, two or more computer systems 1500 coupled by communication link 1510 (e.g., LAN, PTSN, or wireless network) may perform the sequence of instructions required to practice the invention in coordination with one another.

Computer system 1500 may transmit and receive messages, data, and instructions, including program, i.e., application code, through communication link 1515 and communication interface 1514. Received program code may be executed by processor 1507 as it is received, and/or stored in disk drive 1510, or other non-volatile storage for later execution. A database 1532 in a storage medium 1531 may be used to store data accessible by the system 1500.

The techniques described may be implemented using various processing systems, such as clustered computing systems, distributed systems, and cloud computing systems. In some embodiments, some or all of the data processing system described above may be part of a cloud computing system. Cloud computing systems may implement cloud computing services, including cloud communication, cloud storage, and cloud processing.

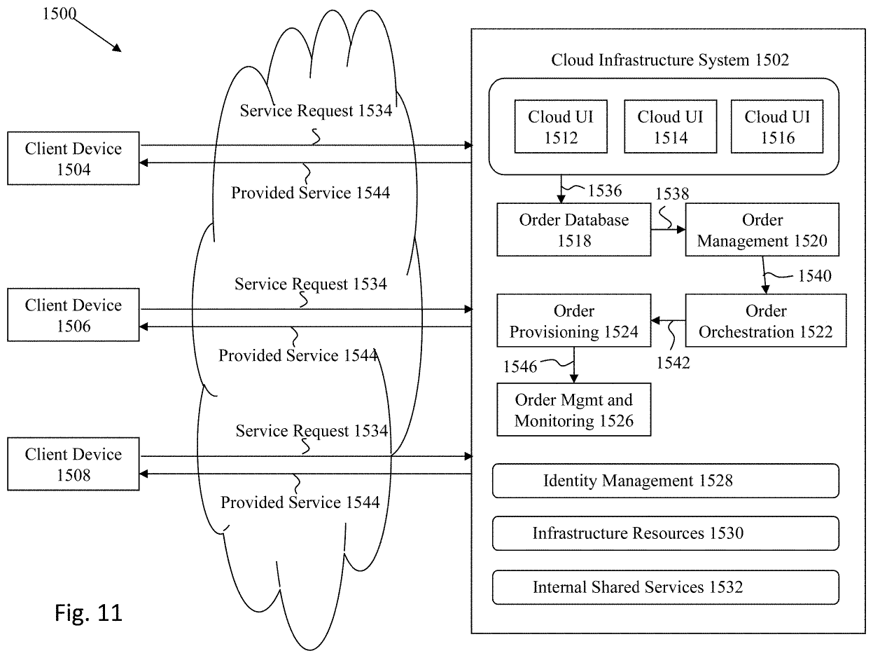

FIG. 11 is a simplified block diagram of one or more components of a system environment 1500 by which services provided by one or more components of an embodiment system may be offered as cloud services, in accordance with an embodiment of the present disclosure. In the illustrated embodiment, system environment 1500 includes one or more client computing devices 1504, 1506, and 1508 that may be used by users to interact with a cloud infrastructure system 1502 that provides cloud services. The client computing devices may be configured to operate a client application such as a web browser, a proprietary client application, or some other application, which may be used by a user of the client computing device to interact with cloud infrastructure system 1502 to use services provided by cloud infrastructure system 1502.

It should be appreciated that cloud infrastructure system 1502 depicted in the figure may have other components than those depicted. Further, the embodiment shown in the figure is only one example of a cloud infrastructure system that may incorporate an embodiment of the invention. In some other embodiments, cloud infrastructure system 1502 may have more or fewer components than shown in the figure, may combine two or more components, or may have a different configuration or arrangement of components.

Client computing devices 1504, 1506, and 1508 may be devices similar to those described above for FIG. 10. Although system environment 1500 is shown with three client computing devices, any number of client computing devices may be supported. Other devices such as devices with sensors, etc. may interact with cloud infrastructure system 1502.

Network(s) 1510 may facilitate communications and exchange of data between clients 1504, 1506, and 1508 and cloud infrastructure system 1502. Each network may be any type of network familiar to those skilled in the art that can support data communications using any of a variety of commercially-available protocols. Cloud infrastructure system 1502 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1502 may include a suite of applications, middleware, and database service offerings that are delivered to a customer in a self-service, subscription-based, elastically scalable, reliable, highly available, and secure manner.

In various embodiments, cloud infrastructure system 1502 may be adapted to automatically provision, manage and track a customer's subscription to services offered by cloud infrastructure system 1502. Cloud infrastructure system 1502 may provide the cloudservices via different deployment models. For example, services may be provided under a public cloud model in which cloud infrastructure system 1502 is owned by an organization selling cloud services and the services are made available to the general public or different industry enterprises. As another example, services may be provided under a private cloud model in which cloud infrastructure system 1502 is operated solely for a single organization and may provide services for one or more entities within the organization. The cloud services may also be provided under a community cloud model in which cloud infrastructure system 1502 and the services provided by cloud infrastructure system 1502 are shared by several organizations in a related community. The cloud services may also be provided under a hybrid cloud model, which is a combination of two or more different models.

In some embodiments, the services provided by cloud infrastructure system 1502 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1502. Cloud infrastructure system 1502 then performs processing to provide the services in the customer's subscription order.

In some embodiments, the services provided by cloud infrastructure system 1502 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1502 may also include infrastructure resources 1530 for providing the resources used to provide various services to customers of the cloud infrastructure system. In one embodiment, infrastructure resources 1530 may include pre-integrated and optimized combinations of hardware, such as servers, storage, and networking resources to execute the services provided by the PaaS platform and the SaaS platform.

In some embodiments, resources in cloud infrastructure system 1502 may be shared by multiple users and dynamically re-allocated per demand. Additionally, resources may be allocated to users in different time zones. For example, cloud infrastructure system 1502 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1532 may be provided that are shared by different components or modules of cloud infrastructure system 1502 and by the services provided by cloud infrastructure system 1502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1502 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1502, and the like.

In one embodiment, as depicted in the figure, cloud management functionality may be provided by one or more modules, such as an order management module 1520, an order orchestration module 1522, an order provisioning module 1524, an order management and monitoring module 1526, and an identity management module 1528. These modules may include or be provided using one or more computers and/or servers, which may be general purpose computers, specialized server computers, server farms, server clusters, or any other appropriate arrangement and/or combination.

In operation 1534, a customer using a client device, such as client device 1504, 1506 or 1508, may interact with cloud infrastructure system 1502 by requesting one or more services provided by cloud infrastructure system 1502 and placing an order for a subscription for one or more services offered by cloud infrastructure system 1502. In certain embodiments, the customer may access a cloud User Interface (UI), cloud UI 1512, cloud UI 1514 and/or cloud UI 1516 and place a subscription order via these UIs. The order information received by cloud infrastructure system 1502 in response to the customer placing an order may include information identifying the customer and one or more services offered by the cloud infrastructure system 1502 that the customer intends to subscribe to.

After an order has been placed by the customer, the order information is received via the cloud UIs, 1512, 1514 and/or 1516. At operation 1536, the order is stored in order database 1518. Order database 1518 can be one of several databases operated by cloud infrastructure system 1518 and operated in conjunction with other system elements. At operation 1538, the order information is forwarded to an order management module 1520. In some instances, order management module 1520 may be configured to perform billing and accounting functions related to the order, such as verifying the order, and upon verification, booking the order. At operation 1540, information regarding the order is communicated to an order orchestration module 1522. Order orchestration module 1522 may utilize the order information to orchestrate the provisioning of services and resources for the order placed by the customer. In some instances, order orchestration module 1522 may orchestrate the provisioning of resources to support the subscribed services using the services of order provisioning module 1524.

In certain embodiments, order orchestration module 1522 enables the management of business processes associated with each order and applies business logic to determine whether an order should proceed to provisioning. At operation 1542, upon receiving an order for a new subscription, order orchestration module 1522 sends a request to order provisioning module 1524 to allocate resources and configure those resources needed to fulfill the subscription order. Order provisioning module 1524 enables the allocation of resources for the services ordered by the customer. Order provisioning module 1524 provides a level of abstraction between the cloud services provided by cloud infrastructure system 1502 and the physical implementation layer that is used to provision the resources for providing the requested services. Order orchestration module 1522 may thus be isolated from implementation details, such as whether or not services and resources are actually provisioned on the fly or pre-provisioned and only allocated/assigned upon request.

At operation 1544, once the services and resources are provisioned, a notification of the provided service may be sent to customers on client devices 1504, 1506 and/or 1508 by order provisioning module 1524 of cloud infrastructure system 1502.

At operation 1546, the customer's subscription order may be managed and tracked by an order management and monitoring module 1526. In some instances, order management and monitoring module 1526 may be configured to collect usage statistics for the services in the subscription order, such as the amount of storage used, the amount data transferred, the number of users, and the amount of system up time and system down time.

In certain embodiments, cloud infrastructure system 1502 may include an identity management module 1528. Identity management module 1528 may be configured to provide identity services, such as access management and authorization services in cloud infrastructure system 1502. In some embodiments, identity management module 1528 may control information about customers who wish to utilize the services provided by cloud infrastructure system 1502. Such information can include information that authenticates the identities of such customers and information that describes which actions those customers are authorized to perform relative to various system resources (e.g., files, directories, applications, communication ports, memory segments, etc.) Identity management module 1528 may also include the management of descriptive information about each customer and about how and by whom that descriptive information can be accessed and modified.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method, comprising:
configuring a customer access control mechanism for a cloud infrastructure resource that is managed by a cloud provider, wherein the customer access control mechanism comprises an access policy for processing an access request from a cloud provider operator to access the cloud infrastructure resource; and
automatically permitting operator access according to the access policy, wherein a check to determine customer approval is not obtained when permitting the operator access.

2. The method of claim 1, wherein the access policy comprises an override condition, and the override condition is checked to determine whether the operator access is permitted without checking to determine the customer approval.

3. The method of claim 2, wherein the access request identifies information evaluated for determination of whether the override condition is satisfied.

4. The method of claim 3, wherein the information includes at least one of a system to be accessed, a scope of access, a category of access, a reason for access, a link to a ticket, or a duration for access.

5. The method of claim 2, wherein the override condition corresponds to at least one of a maintenance_window, a hardware event, or a security_incident.

6. The method of claim 5, wherein the maintenance_window is checked against service metadata, the hardware event is checked against operator ticketing, or the security_incident is checked against security ticketing.

7. The method of claim 1, wherein the operator access that is performed without checking for the customer approval comprises at least one of a diagnosis operation, a maintenance operation, a hypervisor-related operation, or a system-level operation.

8. The method of claim 1, wherein multiple override requests are subject to an additional approval process.

9. A computer program product embodied on a computer readable medium, the computer readable medium having stored thereon a sequence of instructions which, when executed by a processor, executes acts comprising:
configuring a customer access control mechanism for a cloud infrastructure resource that is managed by a cloud provider, wherein the customer access control mechanism comprises an access policy for processing an access request from a cloud provider operator to access the cloud infrastructure resource; and
automatically permitting operator access according to the access policy, wherein a check to determine customer approval is not obtained when permitting the operator access.

10. The computer program product of claim 9, wherein the access policy comprises an override condition, and the override condition is checked to determine whether the operator access is permitted without checking to determine the customer approval.

11. The computer program product of claim 10, wherein the access request identifies information evaluated for determination of whether the override condition is satisfied.

12. The computer program product of claim 11, wherein the information includes at least one of a system to be accessed, a scope of access, a category of access, a reason for access, a link to a ticket, or a duration for access.

13. The computer program product of claim 10, wherein the override condition corresponds to at least one of a maintenance_window, a hardware event, or a security_incident.

14. The computer program product of claim 13, wherein the maintenance_window is checked against service metadata, the hardware event is checked against operator ticketing, or the security incident is checked against security ticketing.

15. The computer program product of claim 9, wherein the operator access that is performed without checking for the customer approval comprises at least one of a diagnosis operation, a maintenance operation, a hypervisor-related operation, or a system-level operation.

16. The computer program product of claim 9, wherein multiple override requests are subject to an additional approval process.

17. A system, comprising:
a processor;
a memory for holding programmable code; and
wherein the programmable code includes instructions executable by the processor for configuring a customer access control mechanism for a cloud infrastructure resource that is managed by a cloud provider, wherein the customer access control mechanism comprises an access policy for processing an access request from a cloud provider operator to access the cloud infrastructure resource; and automatically permitting operator access according to the access policy, wherein a check to determine customer approval is not obtained when permitting the operator access.

18. The system of claim 17, wherein the access policy comprises an override condition, and the override condition is checked to determine whether the operator access is permitted without checking to determine the customer approval.

19. The system of claim 18, wherein the access request identifies information evaluated for determination of whether the override condition is satisfied.

20. The system of claim 19, wherein the information includes at least one of a system to be accessed, a scope of access, a category of access, a reason for access, a link to a ticket, or a duration for access.

21. The system of claim 18, wherein the override condition corresponds to at least one of a maintenance_window, a hardware event, or a security_incident.

22. The system of claim 21, wherein the maintenance_window is checked against service metadata, the hardware event is checked against operator ticketing, or the security_incident is checked against security ticketing.

23. The system of claim 17, wherein the operator access that is performed without checking for the customer approval comprises at least one of a diagnosis operation, a maintenance operation, a hypervisor-related operation, or a system-level operation.

24. The system of claim 17, wherein multiple override requests are subject to an additional approval process.
